(19) United States
(12) Patent Application Publication
(10) Pub. No.: US 2024/0127992 A1
(43) Pub. Date: Apr. 18, 2024

(54) RARE EARTH METAL-FREE HARD MAGNETS

(71) Applicant: MAX PLANCK GESELLSCHAFT ZUR FÖRDERUNG DER WISSENSCHAFTEN EV, München (DE)

(72) Inventors: Claudia FELSER, Halle (DE); Yangkun HE, Dresden (DE)

(73) Assignee: MAX PLANCK GESELLSCHAFT ZUR FÖRDERUNG DER WISSENSCHAFTEN EV, München (DE)

(21) Appl. No.: 18/547,086

(22) PCT Filed: Feb. 21, 2022
(86) PCT No.: PCT/EP2022/054229

§ 371 Date: Aug. 18, 2023

(30) Foreign Application Priority Data
Feb. 24, 2021 (EP) 21158975.9

(51) Int. Cl. H01F 1/047; B22F 1/10; C22C 33/02; C22C 38/00; C22C 38/02; C22C 38/10

(52) U.S. Cl. CPC H01F 1/047; B22F 1/10; C22C 33/02; C22C 38/002; C22C 38/02; C22C 38/10; H01F 41/0266

(57) ABSTRACT

The invention relates to materials with permanent magnetic properties—also known as hard magnets—having the formula (Fe_{1-y} Co_{y})₂P₁₋ₓZₓ with Z=Si, Ge, B, As; and 0.5≤x≤0.5, and 0.05≤y≤0.3. The invention further relates to the hard magnet itself and a process for making the hard magnets.

### BACKGROUND OF THE INVENTION

The invention relates to materials with permanent magnetic properties also known as hard magnets. A good hard magnet or permanent magnet should produce a high magnetic field, should withstand external magnetic forces, which would demagnetize it, and should be mechanically robust.

Permanent magnetic materials play an important role in many areas of life, for example in medical diagnostics, magnetic circuits and in spintronics.

Typically, hard magnetic materials are ferromagnetic materials, which are characterized by a high remanence and high coercivity.

When a ferromagnetic material is magnetized in one direction, it will not relax to zero magnetization when the imposing magnetizing field is removed. The amount of magnetization it retains at zero imposing field is called remanence. In order to reverse the magnetization back to zero, a magnetic field in the opposite direction must be applied; the required amount of opposite magnetic field for demagnetization is called coercivity. When an alternating magnetic field is applied to the material, its magnetization will follow a loop called hysteresis loop. This hysteresis phenomenon is related to the existence of magnetic domains (“Weiss domains”). Some ferromagnetic materials will retain an imposed magnetization almost indefinitely and are, thus, useful as “permanent magnets”.

Three intrinsic properties of a magnetic material are important for selecting a potential permanent magnet:
the Curie temperature (T_{C}), above which the cooperative magnetism of a ferromagnetic or ferrimagnetic material disappears,
the saturation magnetization (Mₛ), which is decisive for the energy density (BH)ₘₐₓ, and
the uniaxial magnetocrystalline anisotropy (K₁), which has an impact on the magnetic hardness parameter κ=\sqrt{K₁/(μ₀Mₛ²)}.

At present, the most used high performance permanent magnets are rare earth metal compounds of samarium and cobalt (Sm—Co) and neodymium, iron and boron (Nd—Fe—B, e.g. Nd₂Fe₁₄B), the latter having a coercivity of about 1.2 T and a remanence of about 1.2 T and maximum energy densities of (BH)ₘₐₓ of about 400 kJm⁻³. However, Dysprosium or Terbium is needed to improve corrosion stability and the intrinsic coercivity. These rare earth elements are “strategic materials” because of their limited resources. Their availability is subject to political constraints. Moreover, because of the susceptibility to corrosion of these materials their service temperatures are limited to below 200° C. and/or they need to be coated to avoid or at least limit oxidation.

So far, there are no real commercial alternatives to the powerful rare earth permanent magnets, because they are superior to all previously known systems because of their magnetic properties. They have a high magnetic anisotropy, since the electrons of the f-shell are shielded from the ligand field and thus the orbital momentum of the shell shows to its advantage. In addition, they can exhibit a high localized magnetic moment, which additionally allows high saturation magnetizations.

A rare earth metal-free alternative is ferrites (e.g. BaFe₁₂O₁₉ or SrFe₁₂O₁₉), which are produced on a large scale. BaFe₁₂O₁₉, for example, has a theoretical (BH)ₘₐₓ at room temperature of 46 kJm⁻³. Its K₁ is 0.33 MJm⁻³, μ₀Mₛ is 0.48 T with a κ of 1.3 at room temperature (300 K). Their use is limited to applications with low energy densities, low cost, and maximum operating temperatures of 250° C.

A further alternative are ALNICO magnets with (BH)ₘₐₓ of about 80 kJm⁻³. The comparatively high (BH)ₘₐₓ for the rare earth metal-free alloy is due to a high remanence of about 1.1 T. Yet, the coercive field strength of μ₀H_{c}˜0.14 T is relatively small, which means that ALNICO magnets bear the risk of irreversible losses even at small magnetic field strengths. Moreover, the K₁ for ALNICO is not strong enough, and its κ is only about 0.5. In addition, the bulk material is very brittle and thus, mechanically fragile. However, their high operating temperatures of max. 550° C. are quite advantageous.

Further candidates for hard magnets are MnAl, Mn₂Ga and MnBi. MnAl-based magnets currently reach a (BH)ₘₐₓ of about 60 kJm⁻³ with Curie temperatures of about 280° C. Their remanence and coercivity correspond to a μ₀Mᵣ of about 0.6 T and a μ₀H_{c} of about 0.4 T. They contain no “critical” elements and are thus relatively cheap. Moreover, with a density of about 5 gcm⁻³, they are also relatively lightweight, but their coercive force of ≤0.5 T is quite small. Bulk magnets and also magnets in the form of thin films with up to (BH)ₘₐₓ˜50 kJm⁻³ can be prepared from MnBi. The hard magnetic property of MnBi is based on the uniaxial symmetry of the hexagonal crystal structure, its out-of-plane magnetization and the strong spin-orbit coupling of the heavy Bi. Unfortunately, all these materials have a first order transition at a high temperature, which makes it impossible to make sintered magnets with high density. These materials can only be made into bonded magnets, which limits their commercial applications.

Binary compounds such as CoPt or FePt, which crystallize in the tetragonal structure type L1₀ can exhibit coercive forces of 2 T. However, the high platinum content is economically disadvantageous.

Also, certain iron phosphites have been studied as rare earth metal-free alternatives. E.g. Fe₂P is a hard magnet at low temperature. It crystalizes in a hexagonal structure; yet its T_{C} is only about 214 K. At room temperature, Fe₂P is paramagnetic. There have been attempts to increase T_{c} into the room temperature range by doping. R. Fruchart, A. Roger, and J. P. Senateur (Journal of Applied Physics 40, 1250, 1969) reported that 15% of the iron in Fe₂P can be replaced by cobalt while maintaining the hexagonal crystal structure. This Co-doped Fe₂P has a Curie temperature of up to 441 K, a μ₀Mₛ of 0.4 T and a K₁ of 0.31 MJm⁻³ at room temperature (K. J. De Vos et al., Journal of Applied Physics 33, 1320, 1962). However, since these values are all smaller than those of BaFe₁₂O₁₉, this Co-doped Fe₂P is of low interest for hard magnet applications.

Substitutions of P with Si, As, Ge and B (Fe₂P₁₋ₓZₓ, Z=Si, As, Ge, B) in Fe₂P have been found to increase T_{C}, yet at the price of a decrease in magnetic anisotropy and the appearance of competing structures such as orthorhombic and cubic structures (F. Guillou et al., Journal of Alloys and Compounds 800, 403-411, 2019). These competing phases are not hard magnetic, and accordingly their formation and presence alongside with the hexagonal Fe₂P phase results in a decrease of (BH)ₘₐₓ.

F. Guillou et al. supra have also reported on a mixture with a composition of Fe_{1.75}Co_{0.2}P_{0.8}Si_{0.2}. Yet, this mixture does not represent a homogeneous compound with unique crystal structure. Rather this mixture includes secondary phases, as evidenced by the XRD data and the magnetization versus temperature curves.

### OBJECT OF THE INVENTION

It was, therefore, an object of the present invention to provide stable rare-earth-metal-free hard magnetic compounds which exhibit a high Curie temperature, a high magnetic anisotropy, as well as a high magnetization which materials have a magnetic performance of preferably equal to or better than BaFe₁₂O₁₉.

According to the present invention, “stable” means exhibiting a single crystal phase, preferably with no phase transition below 1000 K, preferably below 1200 K, and more preferred below 1500 K. Preferably, it also means that the compositional change is less than 1 wt.-%, preferably less than 0.5 wt.-%, and more preferred less than 0.1 wt.-% (based on the mass of the crystallographically pure compound) when being exposed to air and/or an acid for 10² hours, preferably 10³ hours, more preferred 10⁴ hours.

A “high T_{C}” means a T_{C} of ≥350 K, preferably ≥400 K and more preferred ≥500 K.

“High anisotropy” means a K₁ of ≥0.40 MJm⁻³, preferably of ≥0.6 MJm⁻³, more preferred ≥0.8 MJm⁻³.

A “high magnetization” means a μ₀Mₛ along the crystallographic c axis of ≥0.4 T, preferably ≥0.6 T, more preferred ≥0.7 T.

### BRIEF DESCRIPTION OF THE INVENTION

The present inventors found that specified co-doping of Fe₂P with Co and Z (Z=Si, Ge, B and As) yielding in a homogeneous hexagonal phase with the formula (Fe_{1-y}Co_{y})₂P₁₋ₓZₓ with Z=Si, Ge, B, As and 0.05≤x≤0.50, 0.05≤y≤0.30 results in an increase of T_{C} and better room temperature hard magnetic properties then many conventional hard magnets. The magnets are stable and can resist acid corrosion. Independently from one another preferably Z is Si and/or x is 0.06≤x≤0.30 and/or 0.06≤y≤0.20. Independently from one another most preferred Z is Si and/or x is 0.08≤x≤0.25 and/or 0.08≤y≤0.15.

The single crystals of these compounds can be grown by the known flux method or by the melting and etching method, which is suitable to make a large quantity of the materials for industrial production.

The intrinsic magnetic properties are determined on single crystals along the c and a axes, which avoid the influence of eventually present soft-magnetic secondary phases.

### BRIEF DESCRIPTION OF THE DRAWINGS

FIG. 1 shows the composition of (Fe_{0.91}Co_{0.09})₂P_{0.89}Si_{0.11} measured by energy-dispersive X-ray spectroscopy (EDX). The inserts show the images of single crystals.

FIG. 2 shows the magnetization curves at 2 and 300 K along both c and a axes.

FIG. 3 shows the magnetization versus temperature curves under applied magnetic fields of 0.01 and 1 T.

FIG. 4 shows the magnetization curves at 300 K along both c and a axes before and after corrosion with 18 wt.-% HCl for one (1) week.

FIG. 5 shows the XRD curve at 300 K for powders of (Fe_{0.88}Co_{0.12})₂P_{0.90}Si_{0.10} produced by the melting and etching method. The observed intensity, the calculated intensity and the corresponding peak position are shown.

### DETAILED DESCRIPTION OF THE INVENTION

Hard magnetic compounds which meet the objects of the present invention are selected from the group consisting of compounds with the formula: (Fe_{1-y}Co_{y})₂P₁₋ₓZₓ (Z=Si, Ge, B, As), 0.05≤x≤0.5 and 0.05≤y≤0.3. Independently from one another preferably Z is Si; and/or x is 0.06≤x≤0.30 and/or 0.06≤y≤0.2. Independently from one another most preferred Z is Si; and/or x is 0.08≤x≤0.25 and/or 0.08≤y≤0.15.

This co-doped Fe₂P phase crystallizes in hexagonal space-group p6̅2m (189). The Wykoff positions of Fe and P are replaced by Co and the Z element respectively according to the atomic fractions in the formula (Fe_{1-y}Co_{y})₂P₁₋ₓZₓ.

A Co content of lower than 0.05, leads to an unfavorable decrease in Curie temperature, which is e.g. at least 50 K lower for the same x and Z. If the Co content is higher than 0.3, the formation of an orthorhombic structure increases which is no longer hexagonal. Hard magnets need a uniaxial anisotropy, such as in hexagonal or tetragonal structures. Therefore, the higher the orthorhombic portion, the lesser the hard magnetic property. Moreover, when too much Co is in the lattice, the moments of Co and Fe become non-collinear. If the Z element content is below the lower limit of 0.05 this again leads to an unfavorable decrease in Curie temperature, which is e.g. at least 30 K lower for the same y. If the Z element content is higher than 0.5, again the formation of an orthorhombic structure increases, resulting in a reduction of hard magnetic property.

Crystals of (Fe_{1-y}Co_{y})₂P₁₋ₓZₓ can be magnetized along the c axis e.g. with a Nd₂Fe₁₄B magnet at room temperature.

At 300 K the saturation magnetization μ₀Mₛ along the c axis of the compounds of the formula (Fe_{1-y}Co_{y})₂P₁₋ₓZₓ is ≥0.4 T, preferably ≥0.6 T, more preferred ≥0.7 T.

The magnetocrystalline anisotropy at 300 K of (Fe_{1-y}Co_{y})₂P₁₋ₓZₓ is ≥0.4 MJm⁻³, preferably ≥0.6 MJm⁻³, more preferred ≥0.8 MJm⁻³.

The Curie temperature of (Fe_{1-y}Co_{y})₂P₁₋ₓZₓ is ≥350 K, preferably ≥400 K, more preferred ≥500 K.

The magnetic hardness parameter κ of (Fe_{1-y}Co_{y})₂P₁₋ₓZₓ is ≥1, preferably →1.2, more preferred ≥1.4 at 300 K.

The anisotropic field Bₐ (the saturation field along the hard axis) is ≥1.5 T, preferably ≥2 T, more preferred ≥2.8 T at 300 K.

The crystals are highly corrosion resistant. After treatment with a mineral acid, e.g. HCl, for a week, the magnetic properties remain unchanged (see FIG. 4). The composition change within the accuracy of the detection (<0.1 wt.-%) by the Wavelength-dispersive X-ray spectroscopy is less than 1 wt.-%, preferably less than 0.5 wt.-%, and more preferred less than 0.1 wt.-% (based on the mass of the pure untreated compound) after being exposed to the HCl (18 wt.-%). This pronounced chemical stability is important for the commercial use of the compounds as hard magnets. Due to this stability there is no need for an additional coating to protect the magnet from corrosion.

Moreover the compounds of the present invention show very high thermo-stability. There is no first order phase transition ≤1000 K, preferably ≤1200 K, more preferred ≤1500 K, which indicates that these compounds can be formed into bulk magnets by sintering the orientated (preferably, parallelly aligned in crystal growth direction) powders with high density.

### Manufacturing Methods

Multiple methods can be used to manufacture the compounds of the present invention. Non-limiting examples are: the sputtering method, the Sn-flux method and the melting and etching method. Preferably, the starting materials are highly pure elements (>99.9 atomic %).

The sputtering technique allows the manufacture of thin layers (films) of the compounds. For this purpose elemental metals and/or alloys of two metals are used as targets in sputtering. The base pressure of the vacuum receiver is preferably ≤10⁻⁶ mbar, more preferably ≤10⁻⁷ mbar and most preferred ≤10⁻⁸ mbar and the deposition preferably takes place at 0.1×10⁻³ mbar to 10×10⁻³ mbar, more preferred at 1×10⁻³ mbar to 5×10⁻³ mbar, and most preferred at 3×10⁻³ mbar within a preferred temperature range of 100° C. to 500° C., more preferred 150° C. to 450° C. and most preferred 200° C. to 400° C. The growth rate of the thin layers is about 0.03 to −0.04 nm/s. After deposition, the thin layers on the substrate within the recipient are preferably vacuum annealed for preferably 5 to 25 minutes, more preferred 10 to 20 minutes and most preferred for about 15 minutes and then slowly cooled to room temperature.

In the Sn-flux method single crystals of (Fe_{1-y}Co_{y})₂P₁₋ₓZₓ can be grown in a Sn matrix. Compared to phosphorus, the Z-element does not enter the Fe₂P-crystal as easy; therefore the Z-element has to be added to the starting element mixture in excess to the aimed composition. Cobalt and iron have almost the same electronegativity; which is why the Co/Fe ratio in the final compound is about the same as in the starting material. Preferably the Z element excess over the aimed (true) content is in the range of 100-300 atomic-%, preferably 120-250 atomic-%, more preferred 130-180 atomic-% in the starting mixture.

In the Sn-flux method the mixture of the elements is sealed in a crucible, e.g. in an alumina tube which in turn is sealed in another tube under reduced pressure, e.g. a quartz tube in vacuum. This tube assembly is then heated to a maximum temperature of about 1500 K according to a defined stepwise temperature/time profile:
Preferably at first it is heated to 570-580 K, preferably about 575 K within 2-4 hours, preferably about 3 hours,
it is then maintained at this temperature over 8-12 hours, preferably about 10 hours,
then heated up to its maximum temperature of 1300-1600 K, preferably about 1500 K within 20-30 hours, preferably about 24 h,
then maintained at this temperature over 20-30 hours, preferably about 24 h,
and then cooled to 750-800 K, preferably about 773 K with a cooling rate of 2-5 K/h, preferably about 3 K/h
and preferably finally centrifuged upon reaching the cooling temperature.

Since the compounds according to the present invention do not react with acid, crystalline powders can also be produced by the melting and etching method. Compared to the flux-method, the composition of the starting materials is almost the same as the composition of the desired compound and only very little material is wasted. The powders of the elements are mixed in a crucible, e.g. a BN crucible, which is then sealed under vacuum e.g. in a Ta-tube. The Ta-tube is slowly heated in vacuum to a temperature above the melting temperature of (Fe_{1-y}Co_{y})₂P₁₋ₓZₓ, e.g. to 1750-1850 K, preferably about 1800 K within 20-30 hours, preferably 24 h. This temperature is maintained for 20-30 hours, preferably 24 h in order to achieve a high degree of homogeneity and then cooled to room temperature, preferably by simply turning off the power of the furnace. The thus obtained ingot is ground into powder and then transferred into a mineral acid like HCl (e.g. 15-20 wt.-%) for 20-30 hours, preferably 24 h to remove eventually present secondary phase(s), which typically is/are present in the initial ingot in an amount from about 2-4 vol.-%.

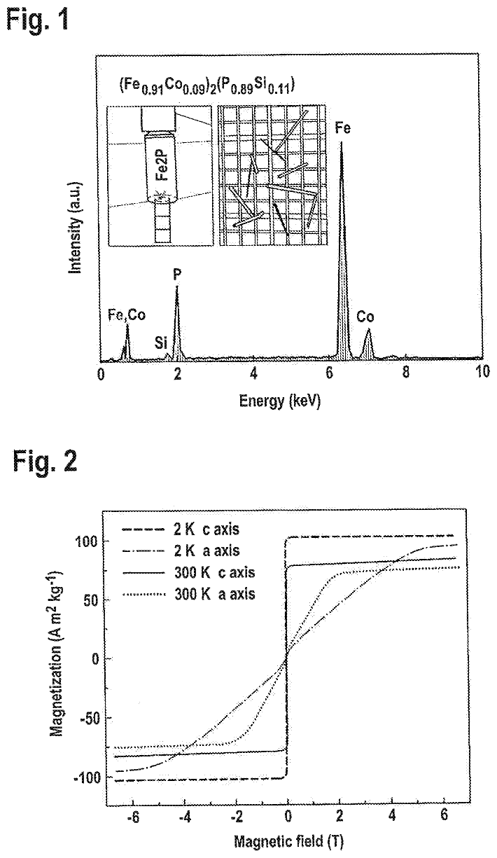

The single crystals are shining needle-like crystals (see FIG. 1 or FIG. 4). The direction parallel to the needle direction is the crystallographic c axis. The composition of the single crystals can be verified by EDX (see FIG. 1).

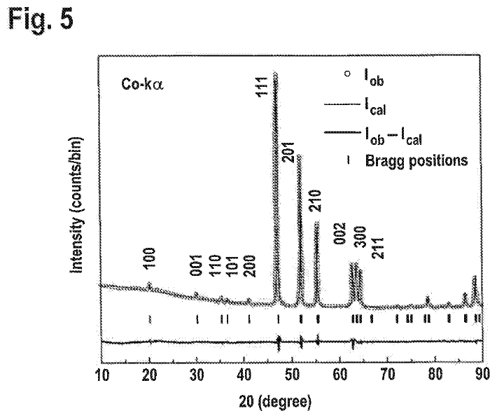

The crystal structure of the polycrystalline sample prepared by the melting and etching method can be verified by XRD (see FIG. 5).

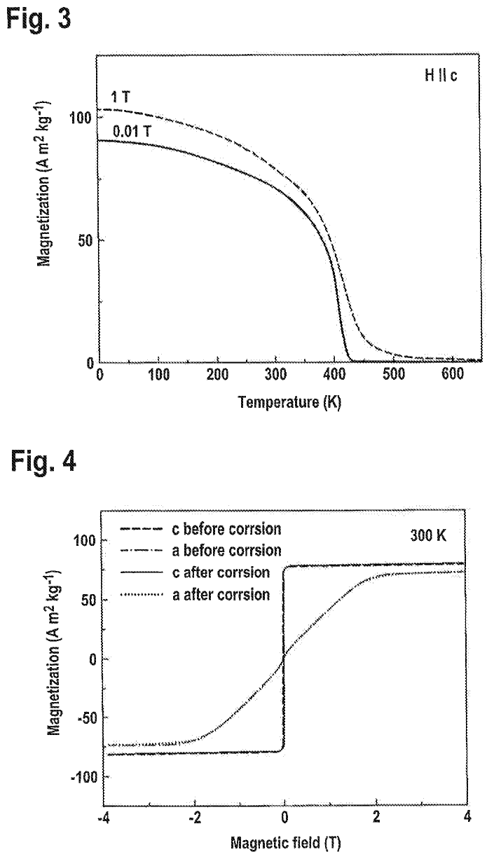

The magnetic properties, including the magnetization, the saturation field (see FIG. 2) and the Curie temperature (see FIG. 3), along both c and a axes are measured with a Vibrating Sample Magnetometer. The magnetocrystalline anisotropy K₁ is ½μ₀MₛHₐ, where Hₐ is the saturation magnetic field along the a axis.

### Manufacture of Magnets for Use

For use as a magnet the compounds of the present invention can e.g. be sintered as raw material or bonded with an appropriate binder material. Sintered magnets are usually stronger and anisotropic but shapes are limited. They are made by pressure forming the raw materials followed by a heating process. Bonded magnets are less strong as sintered ones but less expensive and can be made into almost any size and shape. For bonded magnets the compounds according to the invention are mixed with 5 to 90 wt.-%, preferably 10 to 60 wt.-%, more preferably 20-40 wt.-% binder, compacted and cured at elevated temperature (e.g. at 50-350° C., preferably at 80-280° C., more preferably at 100-200° C.; depending on the binder used). They are isotropic, i.e. they can be magnetized in any direction. The molding process can e.g. be an injection molding or a compression bonding process. Typical binder types are Nylon, Polyamide, Polyphenylene sulfide (PPS) and Nitrile Butadiene Rubber (NBR).

### EXAMPLES

The invention is explained in more detail with reference to the following examples.

### Example 1

Manufacture of Single Crystals of (Fe_{0.91}Co_{0.09})₂P_{0.89}Si_{0.11}

The initial atomic ratio before crystal growth is Fe:Co:P:Si:Sn=1.8:0.2:0.8:0.3:20, the final product has the composition with an atomic ratio of Fe:Co:P:Si=1.82:0.18:0.89:0.11.

The saturation magnetization along c axis at 300 K is μ₀Mₛ=0.68 T. The saturation field along the a axis is Bₐ=μ₀Hₐ=2.3 T. The magnetocrystalline anisotropy is K₁=0.63 MJm⁻³. The Curie temperature Tc=414 K.

After sinking into the 18% (mass) HCl for a week, the magnetic properties remain unchanged.

FIG. 1 shows the composition measured by EDX. The inserts show the images of needle-shaped single crystals. The crystals can be magnetized along the c axis with a Nd₂Fe₁₄B magnet at room temperature.

FIG. 2 shows the magnetization curves at 2 and 300 K along both c and a axes.

FIG. 3 shows the magnetization versus temperature curves under applied magnetic fields of 0.01 and 1 T. The Curie temperature deduced by the 0.01 T curve is 414 K.

FIG. 4 shows the magnetization curves at 300 K along both c and a axes before and after corrosion in 18 wt.-% HCl for one week. The insert shows the shining surface after corrosion. The composition was not changed within the accuracy of the detection (<0.1%) by the Wavelength-dispersive X-ray spectroscopy.

FIG. 5 shows the XRD result of the polycrystalline powder produced by the melting and etching method. There is only a single phase of the Fe₂P-type hexagonal structure.

The melting temperature of (Fe_{0.91}Co_{0.09})₂(P_{0.89}Si_{0.11}) is 1520 K. Below this temperature, no first order transition exists.

### Example 2

Manufacture of Single Crystals of (Fe_{0.91}Co_{0.09})₂P_{0.86}Si_{0.14}

(Fe_{0.91}Co_{0.09})₂P_{0.86}Si_{0.14} was prepared in the same way as described in Example 1 but using an initial atomic ratio before crystal growth of Fe:Co:P:Si:Sn=1.8:0.2:0.78:0.22:20

### Example 3

Manufacture of Single Crystals of (Fe_{0.91}Co_{0.09})₂P_{0.81}Si_{0.19}

(Fe_{0.91}Co_{0.09})₂P_{0.81}Si_{0.19} was prepared in the same way as described in Example 1 but using an initial atomic ratio before crystal growth of Fe:Co:P:Si:Sn=1.8:0.2:0.73:0.27:20

### Example 4

Manufacture of Single Crystals of (Fe_{0.92}Co_{0.08})₂P_{0.78}Si_{0.22}

(Fe_{0.92}Co_{0.08})₂P_{0.78}Si_{0.22} was prepared in the same way as described in Example 1 but using an initial atomic ratio before crystal growth of Fe:Co:P:Si:Sn=1.8:0.2:0.67:0.33:20

### Example 5

Manufacture of (Fe_{0.88}Co_{0.12})₂P_{0.90}Si_{0.10} Powder

The initial atomic ratio before reaction is Fe:Co:P:Si=1.78:0.22:0.89:0.11, the final product has the composition with an atomic ratio of Fe:Co:P:Si=1.76:0.24:0.90:0.10.

Table 1 shows the properties of the compounds according to the examples compared to Fe₂P, MnAl, MnBi, Mn₂Ga and BaFe₁₂O₁₉. The properties of (Fe_{0.88}Co_{0.12})₂P_{0.90}Si_{0.10} are not included since the sample is a powder where properties along the crystallographic axes could not be determined.

TABLE 1

| | μ₀Mₛ | μ₀Mₛ | K₁ | | K₁ | | | | (BH)ₘₐₓ |
|---|---|---|---|---|---|---|---|---|---|
| | [T] @ | [T] @ | [MJm⁻³] | Bₐ @ | [MJm⁻³] | Bₐ @ | T_{c} | κ @ | in theory |
| | 2K | 300K | @ 2K | 2K | @ 300K | 300K | [K] | 300K | [kJm⁻³] |
| (Fe_{0.91}Co_{0.09})₂ | 0.89 | 0.68 | 2.17 | 6.2 | 0.63 | 2.3 | 414 | 1.3 | 92.5 |
| (P_{0.89}Si_{0.11}) | | | | | | | | | |
| (Fe_{0.91}Co_{0.09})₂ | 1.11 | 0.90 | 2.17 | 4.9 | 0.89 | 2.5 | 451 | 1.2 | 162 |
| (P_{0.86}Si_{0.14}) | | | | | | | | | |
| (Fe_{0.91}Co_{0.09})₂ | 1.09 | 0.92 | 1.97 | 4.5 | 0.86 | 2.4 | 480 | 1.1 | 170 |
| (P_{0.81}Si_{0.19}) | | | | | | | | | |
| (Fe_{0.92}Co_{0.08})₂ | 0.82 | 0.71 | 1.49 | 4.6 | 0.81 | 2.8 | 506 | 1.4 | 101 |
| (P_{0.78}Si_{0.22}) | | | | | | | | | |
| Fe₂P | 1.03 | — | 2.36 | 6.5 | — | — | 214 | — | — |
| BaFe₁₂O₁₉ | 0.72 | 0.48 | 0.45 | 1.7 | 0.33 | 1.7 | 740 | 1.3 | 46.0 |
| MnAl | | 0.75 | | | 1.7 | 5.7 | 650 | 2 | 113 |
| MnBi | | 0.73 | | | 0.90 | 3.1 | 633 | 1.5 | 107 |
| Mn₂Ga | | 0.59 | | | 2.35 | 10 | 770 | 2.4 | 69.6 |

The error bar for the Curie temperature is ±5 K.

1. A hard magnetic material having the formula:
(Fe_{1-y}Co_{y})₂P₁₋ₓZₓ
with Z=Si, Ge, B, As; and
0.05≤x≤0.5, and
0.05≤y≤0.3.

2. The hard magnetic material according to claim 1, wherein Z is Si.

3. The hard magnetic material according to claim 1, wherein 0.08≤x≤0.25 and 0.08≤y≤0.15.

4. The hard magnetic material according to claim 1, having the formula (Fe_{0.91}Co_{0.09})₂P_{0.89}Si_{0.11}, (Fe_{0.91}Co_{0.09})₂P_{0.86}Si_{0.14}, (Fe_{0.91}Co_{0.09})₂P_{0.81}Si_{0.19} or (Fe_{0.92}Co_{0.08})₂P_{0.78}Si_{0.22}.

5. The hard magnetic material according to claim 1, having a saturation magnetization μ₀Mₛ along a c axis at 300 K of ≥0.4 T.

6. The hard magnetic material according to claim 1, having a magnetocrystalline anisotropy K₁ at 300 K of ≥0.4 MJm⁻³.

7. The hard magnetic material according to claim 1, having a Curie temperature of ≥350 K.

8. The hard magnetic material according to claim 1, having a magnetic hardness parameter K of ≥1 at 300 K.

9. The hard magnetic material according to claim 1, exhibiting a compositional change of less than 1 wt.-% after being exposed to the HCl (wt.-18%) for a week.

10. The hard magnetic material according to claim 1, exhibiting no first order transition ≤1000 K.

11. A hard magnet comprising a hard magnetic material according to claim 1 which has been magnetized with a permanent magnet or an electromagnet.

12. A hard magnet comprising a hard magnetic material according to claim 1 and a binder material.

13. The hard magnet according to claim 12, wherein the binder is selected from one or more members of the group consisting of nylon, polyamide, polyphenylene sulfide (PPS) and nitrile butadiene rubber (NBR).

14. A method of making a hard magnetic material according to claim 1, comprising the steps of sealing a mixture of elements Fe, Co and Z with Z=Si, Ge, B, As of a desired composition and then heating and cooling the sealed mixture according to a stepwise temperature/time profile.
